(19) United States
(12) Patent Application Publication
(10) Pub. No.: US 2008/0232201 A1
(43) Pub. Date: Sep. 25, 2008

(54) Anti-Shock Optical Recording and Reproducing Device

(75) Inventor: Yu Zhou, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,314

(22) PCT Filed: Jan. 19, 2005
(86) PCT No.: PCT/IB2005/000166

§ 371 Date: Jul. 20, 2006

(30) Foreign Application Priority Data
Jan. 26, 2004 (EP) 04300044.7

(51) Int. Cl. G11B 7/00

(52) U.S. Cl. 369/44.11; 369/292

(57) ABSTRACT

The present invention relates to an optical recording and reproducing device comprising an optical pick-up unit, position means for moving roughly the optical pick-up unit with respect to a desired position on an optical disc, an actuator for moving the optical pick-up unit relative to the position means in a radial direction of the optical disc, and a servo processor for delivering a control signal (u(k)) from a measured radial error signal (x(k)) derived from the optical pick-up unit. Said servo processor further comprises: —a state estimator (SEST) for delivering an estimated radial error signal ( ) and a predicted radial error signal ( ) on the basis of the measured radial error signal (x(k)) and of the control signal (u(k)); and—a shock detector (SDET) for delivering a shock indication (S_out) on the basis of the estimated radial error signal, of the predicted radial error signal, and of a sum (CA(k)) of the signals delivered by the at least two regions of the optical sensor.

### FIELD OF THE INVENTION

The present invention relates to an optical recording and reproducing device.

The present invention further relates to a servo processor for use in an optical recording and reproducing device and a processing method for use in an optical recording and reproducing device.

The present invention may be used, for example, in optical data drives, portable and mobile applications and recordable drives (CDRW, DVDRW) where the anti-shock performance is of great importance.

### BACKGROUND OF THE INVENTION

There are conventionally two ways of improving the optical drive's anti-shock performance, the first one through mechanism suspension design and the second one through shock robustness improvement of servo system.

Conventional suspension design can efficiently absorb influence of shock in the low frequency range, usually below 100 Hz. But the disturbance influence to the tracking performance at a comparatively higher frequency range has also to be suppressed through extra servo controller device, conventionally by increasing the servo loop bandwidth. However, increasing servo loop bandwidth increases the loop sensitivity to noise such as disc defects in the low frequency range. That is why detecting accurately and promptly shock becomes critical for applications based on anti-shock measurements. U.S. Pat. No. 6,163,429 discloses a shock-detection method used in an optical disc drive. Said shock-detection method is based on the use of the radial error signal of the laser beam. This radial error signal is filtered in a correlation filter and fed into a comparator, which compares the error signal with a predetermined value and generates a binary output indicating whether a shock has or has not been detected.

However, this method is not able to detect properly a sudden rise in the radial error signal caused by disturbances such as disc defects. Moreover, it may not be fast enough to let the servo controller react.

### SUMMARY OF THE INVENTION

It is an object of the invention to propose an optical recording and reproducing device, which is less sensitive to shock during playing and recording than the one of the prior art.

To this end, the optical recording and reproducing device in accordance with the invention comprises:

an optical pick-up unit including an optical sensor divided into at least two regions;

a servo processor for delivering a control signal from a measured radial error signal delivered by the optical pick-up unit;

said servo processor further comprising:

a state estimator for delivering an estimated radial error signal and a predicted radial error signal on the basis of the measured radial error signal and of the control signal; and

a shock detector for delivering a shock indication on the basis of the estimated radial error signal, of the predicted radial error signal, and of a sum of the signals delivered by the at least two regions of the optical sensor.

The present invention is based on the fact that the sum signal derived from the optical sensor remains at the same level during a shock and in the absence of shock. But during disc defects, said sum signal either drops or increases due to a decrease or increase, respectively, of light intensity reflected by a disc and caused by the disc defects. As a consequence, occurrence of a shock can be accurately and promptly detected thanks to the estimated radial error signal, the predicted radial error signal, and said sun signal.

The present invention also relates to the servo processor for use in such an optical recording and reproducing device. It finally relates to a processing method for use in said optical recording and reproducing device.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is a block diagram of an architecture of a servo processor in accordance with the invention;

FIG. 2 is a block diagram of a state estimator;

FIG. 3 is a block diagram of a shock detector in accordance with the invention;

FIG. 4 is a block diagram of a memory loop; and

FIG. 5 is a curve representing a frequency response spectrum of a radial error signal with shock and without shock.

### DETAILED DESCRIPTION OF THE INVENTION

The present invention proposes an optical recording and reproducing device (e.g. an optical drive), which is more robust to shock.

In an embodiment of the optical recording and reproducing device according to the invention, the device comprises an optical pick-up unit movably mounted on positioning means for roughly positioning the optical pick-up unit with respect to a desired position on a disc. The positioning means is usually implemented by a sledge. The optical pick-up unit includes a semiconductor laser for delivering a laser beam, an objective lens focusing the laser beam on the disc and an optical sensor (e.g. laser diodes) detecting the light reflected from said disc. The optical sensor is divided into at least two regions, a front half region and a rear half region. As an example, the optical sensor is divided into four regions, two regions being arranged to receive light reflected from the front half of a laser spot formed on the disc while the two other regions are arranged to receive light reflected from the rear half of the laser spot. An adder is then adapted to generate a sum signal from a sum of each signal generated by one of the four regions in response to the reflected light beam.

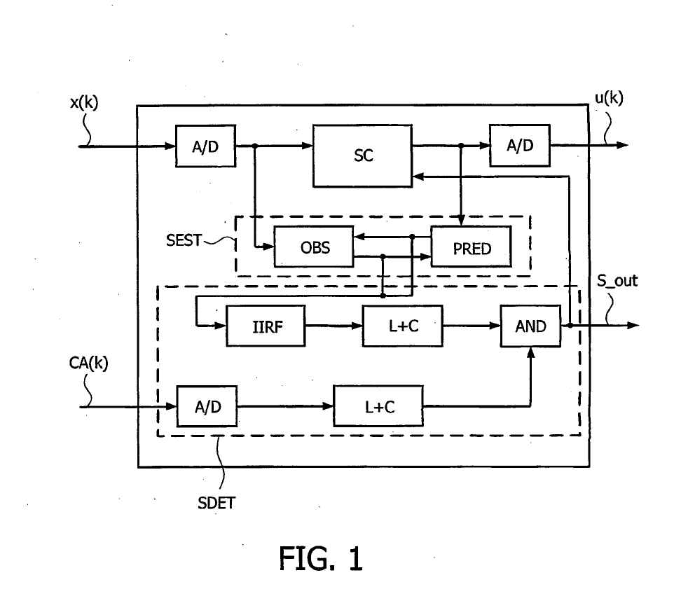

During operation of the device, the optical pick-up unit is controlled by an actuator for moving the optical pick-up unit relative to the positioning means in a radial direction of the disc so as to fine position the optical pick-up unit with respect to the desired position on the disc. The actuator comprises a servo-tracking controller for anti-shock control of the recording and reproducing device, as illustrated in FIG. 1. Said servo-tracking controller SC is implemented within a servo digital servo processor DSP. The digital servo processor comprises a state estimator SEST for estimating an estimated radial error x̅(k) and an estimated velocity v̅(k) of the actuator. Said state estimator has an input responsive to a measured radial error x(k) derived from the optical pick-up unit and another input responsive to a control signal u(k). The measure radial error x(k) is generated by a 3-beam method know to a person skilled in the art and depicted for example in the book entitled “The CD-ROM Drive—A Brief System Description”, by Sorin G. Stan, Kluwer Academic Publishers, 1998.

Said digital servo processor also comprises a shock detector SDET for supplying a shock interrupt signal under control of information supplied by the state estimator to an input of the shock detector. Said shock detector has multiple inputs and a single output. The digital servo processor finally comprises the servo controller SC for supplying the control signal u(k) to the actuator based on information derived from the shock detector which receives information from the state estimator, the servo controller also feeding back said control signal to the state estimator. The state estimator and the shock detector run at the servo processor clock frequency of 22 kHz.

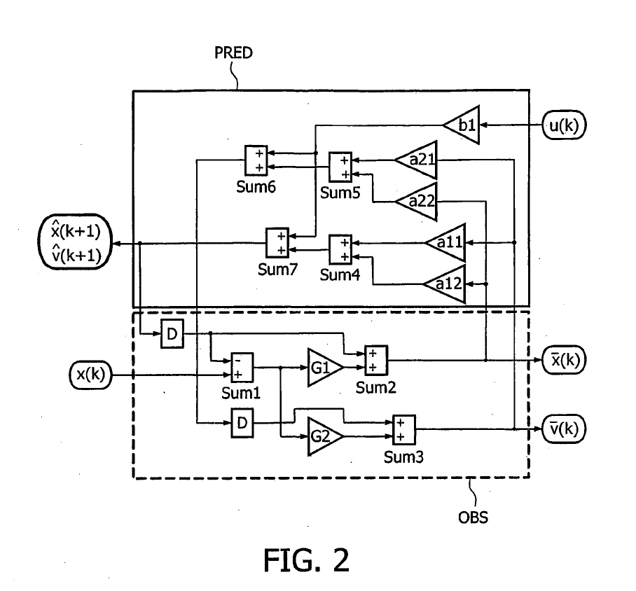

The state estimator is adapted to estimate an entire state based on a measurement of one of the state elements. For the digital servo processor, the state estimator estimates the actuator position, velocity and the control signal based on the measurement of the radial error signal. FIG. 2 represents a conventional state estimator. The state estimator estimates a radial laser beam position error signal at a time k, x̅(k)and a corresponding estimated velocity v̅(k). The estimated states are then delivered to the shock detector to predict the occurrence of shock.

The state estimator mainly comprises two blocks: a state observer OBS and a state predictor PRED. A measured radial error signal x(k) at a time k is provided to the state observer block which estimates a current state of the actuator including the estimated radial error signal x̅(k) and the estimated velocity v̅(k) of the actuator, as follows:

x̅(k)=\hat{x}(k+1)/z+Lᵣₑₛ(x(k)−\hat{x}(k+1)/z)

v̅(k)=\hat{v}(k+1)/z+Lᵥ(v(k)−\hat{v}(k+1)/z)

where Lᵣₑₛ and Lᵥ are the estimator gain provided by a linear quadratic regulator LQR method according to a principle known to a person skilled in the art. The estimated states together with the current control signal u(k) are delivered to the state predictor to predict the states \hat{x}(k+1) and v(k+1) of the actuator at a next time k+1, as follows:

\hat{x}(k+1)=a11. x̅(k)+a12. v̅(k)+b1.u(k)

\hat{v}(k+1)=a21. x̅(k)+a22. v̅(k)+b1.u(k)

where a11, a12, a21, a22 and b1 are constant calculated from the characteristics of the actuator. The use of state estimator allows to quickly detecting the occurrence of a shock.

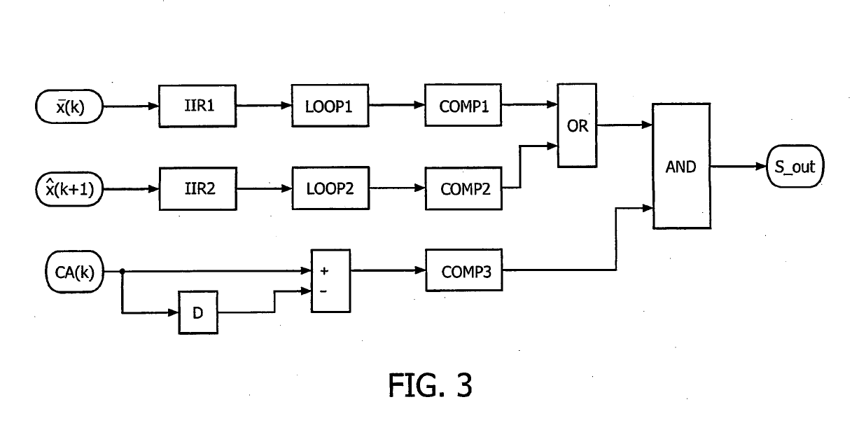

The shock detector mainly comprises 4 parts: a set of 2 band-pass filters, a set of 2 memory loops, and a set of 3 comparators. FIG. 3 shows the implementation of such a shock detector.

The band-pass filters IIR1 and IIR2 are preferably of the infinite impulse response IIR type. Said filters are, for example, a 4th order Elliptic filter defined by the following function H:

$$H ( z ) = \frac{{b}_{1} + {b}_{2} {z}^{- 1} + {b}_{3} {z}^{- 2} + {b}_{4} {z}^{- 3} + {b}_{5} {z}^{- 4}}{{a}_{1} + {a}_{2} {z}^{- 1} + {a}_{3} {z}^{- 2} + {a}_{4} {z}^{- 3} + {a}_{5} {z}^{- 4}}$$

where a1 to a5, b1 to b5 are design coefficients that can be adjusted according to the dynamic characteristics of the optical drive.

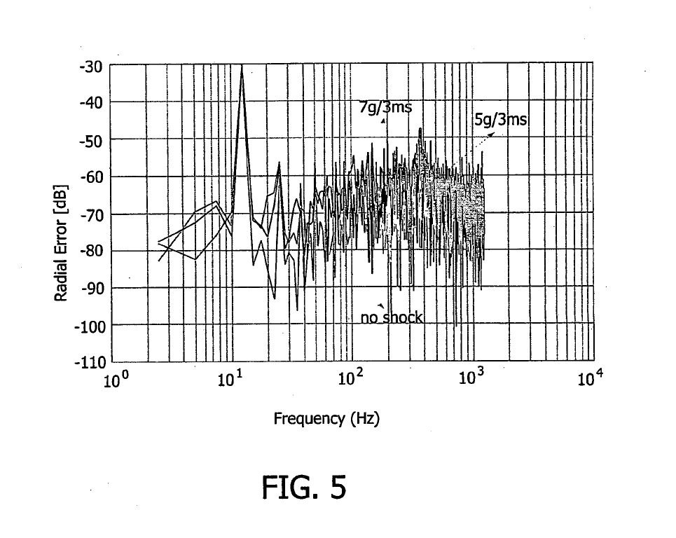

Each band-pass filter is adapted to receive the estimated radial error signal x̅(k) or predicted radial error signal \hat{x}(k+1) and to deliver a corresponding filtered radial error signal FIL. It is designed such that it filters the influence of shock in the low frequency range, for example lower than 100 Hz, and that it filters high frequency noise, for example higher than 1000 Hz. In the case of a Philips Mercury 2 DVD drive, the shock influence on the radial error signal in the low frequency range can be absorbed by the suspension design. It is the shock energy in a higher frequency range that excited the actuator and caused a sudden rise in the position error. FIG. 5 shows the frequency response spectrum of a radial error signal when different levels of shock occurred. It can be seen that the main influence of shock that lead to a radial laser beam off track lies in the middle frequency range, more exactly between 20 Hz and 1000 Hz. The filter coefficients are for example set as follows:

a1=1.0, a2=−2.0981, a3=1.6417, a4=−0.8443, a5=0.3130

b1=0.2796, b2=−0.1471, b3=−0.2637, b4=−0.1471, b5=0.2796

so that the radial error information in the frequency range lying between 100 Hz and 1000 Hz is extracted.

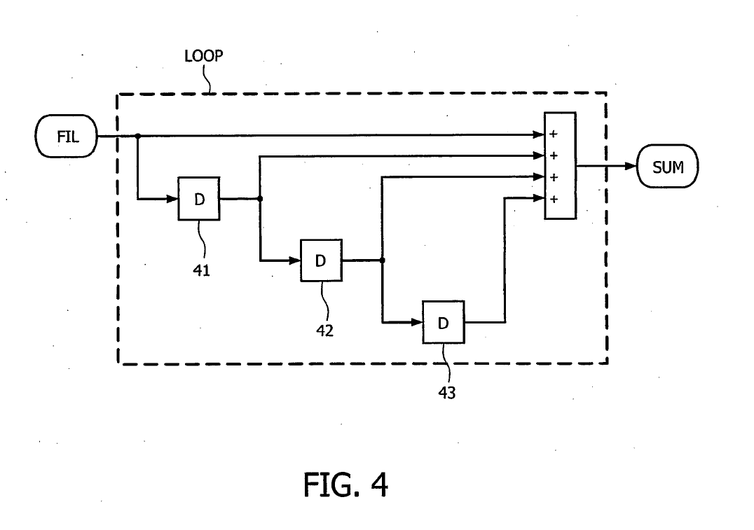

The memory loops LOOP1 and LOOP2 are connected in series with the band-pass filters IIR1 and IIIR2, respectively. Each memory loop is adapted to receive the filtered radial error signal FIL and to deliver a cumulative radial error signal SUM. It is, for example, a 3-tap FIFO. Such a memory loop is able to memorize and to add 4 consecutive filtered radial error signals for a good and reliable detection of the occurrence of sudden changes in the radial error signal. FIG. 4 shows an implementation of such a memory loop, where the block D represents a delay line. It will be apparent to a person skilled in the art that the memory loop can use more or less than 4 consecutive radial error signals. The choice of the memory loop order (i.e. the number of consecutive filtered error signals to be added) depends on the signal processing frequency used compared with the shock.

The memory loop is also designed in order to prevent shock-out flag oscillation when the position error signal vibrates too much during the shock (i.e. the shock detection flag is frequently on and off when the radial error signal crosses zero during one shock). The use of a memory loop allows to keeping the shock indicator signal stable during shocks, instead of an agitated high-low-high-low shock on flag caused by high frequency oscillation excited by the shocks.

First and second comparators COMP1 and COMP2 connected in series with the memory loops LOOP1 and LOOP2 compare the cumulative radial error signal SUM with predetermined values as shown in the 2 following conditions (1) and (2):

SUM≧V_{high limit1}and SUM not≦V_{low limit} (1)

or

SUM≧V_{high limit2}and SUM not≦V_{low limit} (2)

where V_{high limit1}, V_{high limit2} and V_{low limit} are design parameters depending on the settings of the band-pass filters and of the actuator signal sensitivity.

The outputs from the two comparators COMP1 and COMP2 are delivered to a logic OR operator. Whenever one of the 2 following condition is met, a binary output 1 is generated at the output of the OR operator to indicate a sudden increase of the position error signal due to disturbance.

The design parameters are determined in such a way that the parameter V_{high limit1} is equivalent to 20% of the track pitch value and the parameter V_{high limit2} is about 25% of the track pitch value. These values have been determined experimentally in the particular case of a cumulative radial error signal corresponding to the sum of 4 consecutive filtered radial error signals. The parameter V_{low limit} is the low limit of the comparator. Said parameter is used together with the memory loop to prevent wrong triggering of the binary output 0 when the radial error signal passes through zero and at the same time indicates that the laser spot is back to a precise tracking. The parameter V_{low limit} is equivalent to 1% of the track pitch value. These values can be adjusted and finalized through testing of a limited number of optical drives of the same type.

A third comparator COMP3 then calculates the variation of the sum signal CA(k) of the optical sensor. Conventionally, if the following condition:

|CA(K)−CA(k−1)|/|CA(k−1)|>5% (3)

is met, it means there is a light intensity deviation caused by disc defects. In this case, the third comparator will then output a binary value equal to 0. Otherwise, a binary output of 1 is generated.

The outputs from the logic OR operator and of the third comparator are then provided to a logic AND operator delivering an output signal S_out. If the output of the AND operator is a binary 1, i.e. condition (1) or (2) is fulfilled, and if condition (3) is fulfilled, i.e. a defect is detected by the third comparator, then the shock detector finally outputs binary 1 indicating a detection of shock. As a consequence, the sum signal is used to distinguish a sudden rise of radial error signal is caused by disc defects or shock.

Any reference sign in the following claims should not be construed as limiting the claim. It will be obvious that the use of the verb “to comprise” and its conjugations do not exclude the presence of any other steps or elements besides those defined in any claim. The word “a” or “an” preceding an element or step does not exclude the presence of a plurality of such elements or steps.

1. An optical recording and reproducing device comprising:
an optical pick-up unit including an optical sensor divided into at least two regions;
a servo processor for delivering a control signal (u(k)) from a measured radial error signal (x(k)) delivered by the optical pick-up unit;
said servo processor further comprising:
a state estimator (SEST) for delivering an estimated radial error signal ( x̅(k)) and a predicted radial error signal (\hat{x}(k+1)) on the basis of the measured radial error signal (x(k)) and of the control signal (u(k)); and
a shock detector (SDET) for delivering a shock indication (S_out) on the basis of the estimated radial error signal, of the predicted radial error signal, and of a sum (CA(k)) of the signals delivered by the at least two regions of the optical sensor.

2. A servo processor for use in an optical recording and reproducing device, said servo processor being adapted to deliver a control signal (u(k)) from a measured radial error signal (x(k)) delivered by an optical pick-up unit, said servo processor comprising:
a state estimator (SEST) for delivering an estimated radial error signal ( x̅(k)) and a predicted radial error signal (\hat{x}(k+1)) on the basis of the measured radial error signal (x(k)) and of the control signal (u(k)); and
a shock detector (SDET) for delivering a shock indication (S_out) on the basis of the estimated radial error signal, of the predicted radial error signal, and of a sum (CA(k)) of the signals delivered by the at least two regions of the optical sensor.

3. A servo processor as claimed in claim 2, wherein the shock detector comprises two band-pass filters (IIR) for filtering the estimated radial error signal ( x̅(k)) and the predicted radial error signal (\hat{x}(k+1)) and designed such that they filter influence of shock in the low frequency range and that they filter high frequency noise.

4. A servo processor as claimed in claim 3, wherein the band-pass filters are of the infinite impulse response type.

5. A servo processor as claimed in claim 3, wherein the shock detector further comprises two memory loops (LOOP1,LOOP2), each memory loop being connected in series with one of the band-pass filters and being adapted to deliver a cumulative radial error signal (SUM) from a set of consecutive filtered radial error signal (FIL) delivered by the corresponding band-pass filter.

6 A servo processor as claimed in claim 5, wherein the shock detector further comprises two comparators (COMP1,COMP2), each comparator being connected in series with one of the memory loops and being adapted to compare the cumulative radial error signal with predetermined thresholds so as to indicate a sudden increase of the radial error signal due to a disturbance.

7. A servo processor as claimed in claim 6, wherein the shock detector further comprises an additional comparator COMP3 for calculating variation of the sum signal (CA(k)) so as to indicate a light intensity deviation caused by a disc defect, a shock being detected if the additional comparator indicates a disc defect and if one of the two comparators indicates a sudden increase of the radial error signal.

8. A processing method for use in optical recording and reproducing device, said method comprising the steps of:
state estimating, adapted to deliver an estimated radial error signal ( x̅(k)) and a predicted radial error signal (\hat{x}(k+1)) on the basis of the measured radial error signal (x(k)) and of the control signal (u(k)); and
shock detecting, adapted to deliver a shock indication (S_out) on the basis of the estimated radial error signal, of the predicted radial error signal, and of a sum (CA(k)) of the signals delivered by the at least two regions of the optical sensor.
